(19) United States
(12) Patent Application Publication
(10) Pub. No.: US 2011/0173486 A1
(43) Pub. Date: Jul. 14, 2011

(54) COMMUNICATION APPARATUS, NETWORK, AND ROUTE CONTROL METHOD USED THEREFOR

(76) Inventor: Tomohiko Yagyu, Tokyo (JP)

(21) Appl. No.: 13/062,767

(22) PCT Filed: Oct. 7, 2009
(86) PCT No.: PCT/JP2009/005212

§ 371 Date: Mar. 8, 2011

(30) Foreign Application Priority Data
Nov. 5, 2008 (JP) 2008-283808

(51) Int. Cl. G06F 11/07; G06F 15/173

(52) U.S. Cl. 714/2; 714/E11.023

(57) ABSTRACT

Provided is a communication apparatus that is capable of enhancing fault resistance of a network. A communication apparatus includes, in a network where messages are exchanged among a plurality of communication apparatuses and route control is performed, a route summary processing means that creates route summary information obtained by summarizing route information of a local apparatus from a route table holding route information used for route control and traffic information between communication apparatuses, the route summary processing means further exchanging the route summary information that is created with other communication apparatuses; and a fault influence degree information processing means that calculates fault influence degree information indicating a degree of influences on traffic and the other communication apparatuses when the local apparatus is in a fault state, the fault influence degree information processing means further exchanging the fault influence degree information that is calculated with the other communication apparatuses; and a route adjustment processing means that adjusts the route table of the local apparatus using the route summary information and the fault influence degree information that are obtained by the local apparatus.

### TECHNICAL FIELD

The present invention relates to a communication apparatus, a network, and a route control method used therefor, and more particularly, to a route control method that reduces influences on data transfer upon occurrence of faults in a router and a link.

### BACKGROUND ART

Dynamic route control (routing) in the IP (Internet Protocol) network is carried out by routing protocols such as OSPF (Open Shortest Path First) disclosed in a non-patent literature 1, RIP (Routing information Protocol) disclosed in a non-patent literature 2 and the like.

Upon occurrence of a fault in a communication apparatus (router) or a line (link), these routing protocols calculate a new route by exchanging route information to recover the communication path. The communication path is basically selected that minimizes the total link cost defined for each link or minimizes the number of routers (number of hops) that are passed through.

One of defects of the dynamic route control is, since recalculation of the route requires a certain period of time, the communication that passes through the router or link with fault is kept interrupted for a few seconds to a several tens of seconds from the occurrence of the fault to the completion of the re-calculation of the route.

One technique for avoiding such a long-term interruption is an IP-FRR (IP Fast Reroute) technique, which is disclosed in a non-patent literature 3. In the IP-FRR technique, an alternative transfer destination (alternative next hop) that is not looped is determined in advance. Accordingly, it is possible to quickly restart packet transfer without waiting for the re-calculation of the route of the routing protocol upon occurrence of a fault in a router or a link.

Another defect is that there is a possibility that the load is concentrated (congested) in a specific router or link for the purpose of selecting the route with minimum cost. A traffic distribution system is one technique for avoiding concentration of traffic. In the OSPF-OMP (OSPF-Optimized Miltipath) disclosed in a non-patent literature 4, each router advertises the link utilization rate or the like to the whale network with the route information, and when there are a plurality of equal-cost routes to the same destination, the traffic is dispersed according to the link utilization rate among the equal-cost routes.

The technique disclosed in the patent literature 1 avoids congestion by switching routes upon detection of congestion. The technique disclosed in the patent literature 2 avoids congestion by specifying the route by a transmission source so as to avoid the congestion area.

### CITATION LIST

### Patent Literature

[Patent literature 1] Japanese Unexamined Patent Application Publication No. 2003-092593
[Patent literature 2] Japanese Unexamined Patent Application Publication No. 2002-368787

### Non Patent Literature

[Non-patent literature 1]
J. Moy, “OSPF version 2”, IETF (Internet Engineering Task Force) RFC (Request For Comments) 2328, April 1998
   [Non-patent literature 2]
G. Malkin, “RIP version 2”, IETF RFC2453, 1998
   [Non-patent literature 3]
A. Atlas et al., “Basic Specification for IP Fast-Reroute: Loop-free Alternates”, IETF Internet draft draft-ietf-rtgwg-ipfrr-spec-base-12.txt, March 2008
   [Non-patent literature 4]
C. Villamizar, “OSPF Optimized Multipath”, IETF Internet draft draft-ietf-ospf-omp-02.txt, 1999

### SUMMARY OF INVENTION

### Technical Problem

As described above, by using the IP-FRR as a technique for enhancing the fault tolerance of the IP network, the packet transfer can be restarted without waiting for the route calculation of the routing protocol upon occurrence of a fault in a link or a router.

However, since not all the destinations have alternative next hops, the packet to the destination that has no alternative next hop is not transferred until the completion of the re-calculation of the route. Hence, there are caused influences such as packet loss due to overflow of transmission queue, or an increase in the delay.

Further, when each router switches to the alternative next hop due to the occurrence of the fault, the bypassed traffic may concentrate on the alternative next hop, which may cause congestion. This congestion causes occurrence of the packet loss, or in some cases down of a router due to overload, for example. In the worst case, the cycle of fault, down of router→traffic bypass to alternative next hop→down of alternative next hop, is repeated, which may result in the whole network being down.

An object of the present invention is to solve the problem stated above, and to provide a communication apparatus, a network, and a route control method used therefor that make it possible to increase fault resistance of the network.

### Solution to Problem

One aspect of a communication apparatus according to the present invention includes, in a network where messages are exchanged among a plurality of communication apparatuses and route control is performed, a route summary processing means that creates route summary information obtained by summarizing route information of a local apparatus from a route table holding route information used for route control and traffic information between communication apparatuses, the route summary processing means further exchanging the route summary information that is created with other communication apparatuses; and a fault influence degree information processing means that calculates fault influence degree information indicating a degree of influences on traffic and the other communication apparatuses when the local apparatus is in a fault state, the fault influence degree information processing means further exchanging the fault influence degree information that is calculated with the other communication apparatuses; and a route adjustment processing means that adjusts the route table of the local apparatus using the route summary information and the fault influence degree information that are obtained by the local apparatus.

A network according to the present invention includes the communication apparatus described above.

A route control method according to the present invention is a route control method used for a network where messages are exchanged among a plurality of communication apparatuses and route control is performed, the method executing the following processing of: route summary processing that creates route summary information obtained by summarizing route information of a local apparatus from a route table holding route information used for route control and traffic information between the communication apparatuses, and exchanges the route summary information that is created with other communication apparatuses; fault influence degree information processing that calculates fault influence degree information indicating a degree of influences on traffic and the other communication apparatuses when the local apparatus is in a fault state, and exchanges the fault influence degree information that is calculated with the other communication apparatuses; and route adjustment processing that adjusts the route table of the local apparatus using the route summary information and the fault influence degree information that are obtained by the local apparatus.

### Advantageous Effects of Invention

The present invention employs the configuration and the operation as described above, thereby making it possible to enhance fault resistance of a network.

### BRIEF DESCRIPTION OF DRAWINGS

FIG. 1 is a block diagram showing a configuration example of a communication apparatus (router) according to an embodiment of the present invention;

FIG. 2 is a diagram showing a part of entry constitution of a route table shown in FIG. 1;

FIG. 3 is a diagram showing a configuration example of a network according to the embodiment of the present invention;

FIG. 4A is a diagram showing one example of a route table of each of routers calculated by an existing routing protocol according to the embodiment of the present invention;

FIG. 4B is a diagram showing one example of a route table of each of routers calculated by an existing routing protocol according to the embodiment of the present invention;

FIG. 4C is a diagram showing one example of a route table of each of routers calculated by an existing routing protocol according to the embodiment of the present invention;

FIG. 5A is a diagram showing one example of traffic information of each of routers shown in FIG. 3;

FIG. 5B is a diagram showing one example of traffic information of each of routers shown in FIG. 3;

FIG. 6A is a diagram showing route summary information of each of routers shown in FIG. 3;

FIG. 6B is a diagram showing route summary information of each of routers shown in FIG. 3;

FIG. 7 is a diagram showing fault influence degree information of each of routers 201 to 204 shown in FIG. 3;

FIG. 8 is a diagram showing adjacent node information extracted by a router 101 shown in FIG. 3;

FIG. 9 is a diagram showing adjacent node information extracted by a router 102 shown in FIG. 3;

FIG. 10 is a diagram showing information of routers adjacent to the router 101 after Step 1 of the route adjustment is completed in the embodiment of the present invention;

FIG. 11 is a diagram showing information of routers adjacent to the router 102 after Step 1 of the route adjustment is completed in the embodiment of the present invention;

FIG. 12 is a diagram showing information of routers adjacent to the router 101 after Step 2 of the route adjustment is completed in the embodiment of the present invention;

FIG. 13 is a diagram showing information of routers adjacent to the router 102 after Step 3 of the route adjustment is completed in the embodiment of the present invention; and

FIG. 14 is a diagram showing route tables of the routers 101 and 102 after route adjustment processing is completed in the embodiment of the present invention.

### DESCRIPTION OF EMBODIMENTS

Next, an embodiment of the present invention will be described with reference to the accompanying drawings. First, description will be made of the outline of a network of the present invention. The network according to the present invention includes, for the purpose of accomplishing the object described above, a route summary processing unit that creates a summary (aggregation) of route information of a local apparatus in each communication apparatus (router) to notify another router of the summary, and receives route summary information from another router to hold the received information; a fault influence degree information processing unit that calculates a fault influence degree of the local apparatus based on the route summary information of another router to notify another router of the fault influence degree, and receives the fault influence degree information from another router to hold the fault influence degree information; and a route adjustment processing unit that adjusts the route of the local apparatus based on the fault influence degree information of another router.

In a communication apparatus according to the present invention, a route summary processing unit creates a summary of route information of a local apparatus to notify another router of the summary, and receives route summary information from another router to hold the route summary information, a fault influence degree information processing unit calculates a fault influence degree of the local apparatus based on the route summary information of another router to notify another router of the fault influence degree, and receives the fault influence degree information from another router to hold the fault influence degree information, and a route adjustment processing unit adjusts the route of the local apparatus based on the fault influence degree information of another router, so as to mitigate the influence degree upon occurrence of a fault in each router in a network and to achieve route control to enhance fault resistance of the network.

As described above, the present invention minimizes the influence given on a user or a network upon occurrence of a fault, thereby being capable of enhancing fault resistance of the network. Here, the influence given on the user or the network in case of a fault means occurrence of transfer interruption of traffic due to a fault of a router or a link, or congestion caused by traffic bypassed to an alternative next hop upon occurrence of a fault.

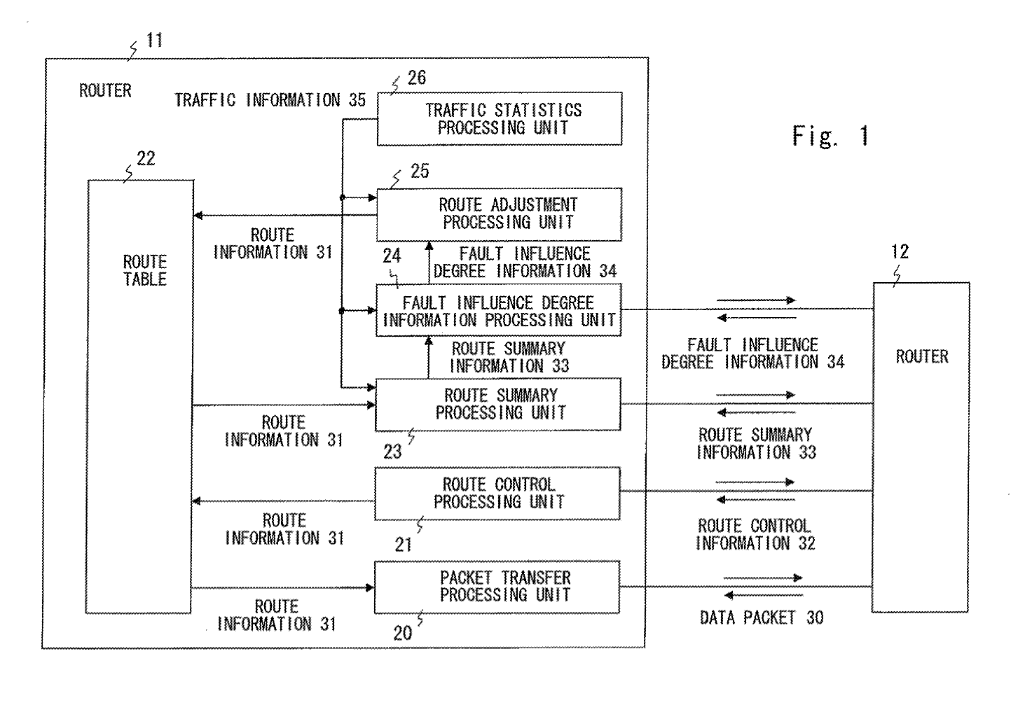

FIG. 1 is a block diagram showing a configuration example of a communication apparatus (router) according to an embodiment of the present invention. In FIG. 1, a router 11 includes a packet transfer processing unit 20, a route control processing unit 21, a route table 22, a route summary processing unit 23, a fault influence degree information processing unit 24, a route adjustment processing unit 25, and a traffic statistics processing unit 26. Further, the router 11 exchanges a data packet 30, route control information 32, route summary information 33, and fault influence degree information 34 with a router 12.

In the route control processing unit 21, route control is performed by the OSPF (Open Shortest Path First) or the RIP (Routing Information Protocol) that are existing routing protocols. Further, the route control processing unit 21 is based on a router in which an alternative next hop upon occurrence of a fault in a current next hop is calculated using the IP-FRR (IP Fast Reroute) or the ECMP (Equal Cost Multi Path). It is assumed that the current next hop and the alternative next hop (route information 31) calculated in the route control processing unit 21 are held in the route table 22.

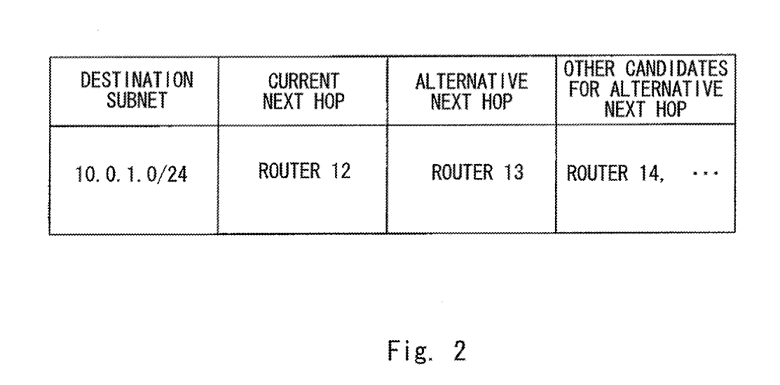

FIG. 2 is a diagram showing a part of entry constitution of the route table 22 shown in FIG. 1. In FIG. 2, the entry of the route table 22 includes a destination prefix, a current next hop, alternative next hops (a plurality of candidates for alternative next hop that are ranked by priority) and the like.

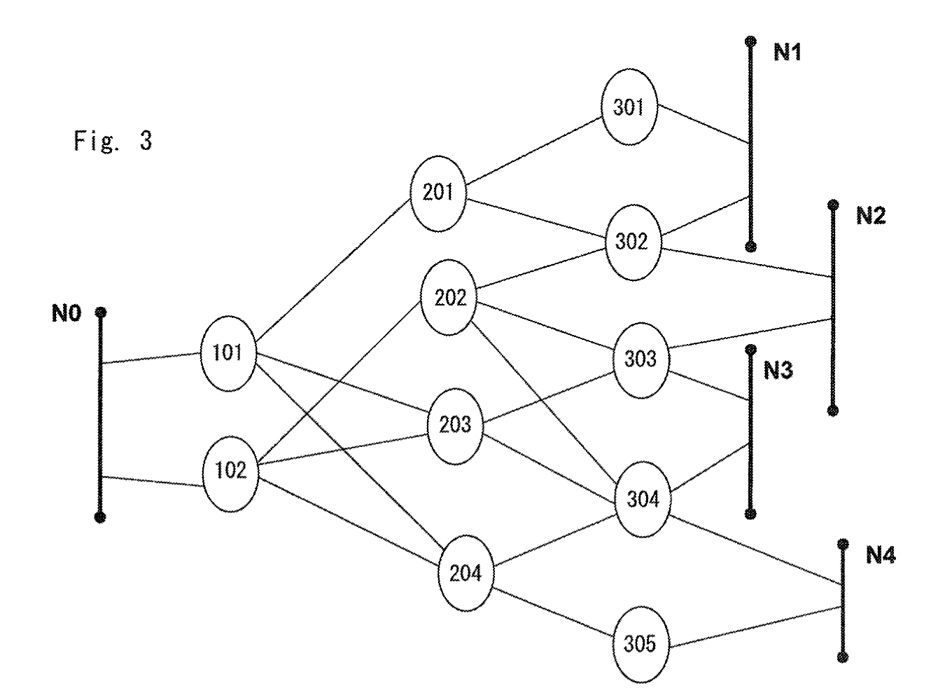

FIG. 3 is a diagram showing a configuration example of the network according to the embodiment of the present invention. In FIG. 3, the network according to the embodiment of the present invention includes five subnets N0 to N4, and 11 routers 101, 102, 201 to 204, and 301 to 305. Each of the routers 101, 102, 201 to 204, and 301 to 305 has a configuration similar to that of the router 11 shown in FIG. 1.

The route control processing unit 21 in each of the routers 101, 102, 201 to 204, and 301 to 305 calculates the route to each of the subnets N0 to N4 using the existing routing protocol.

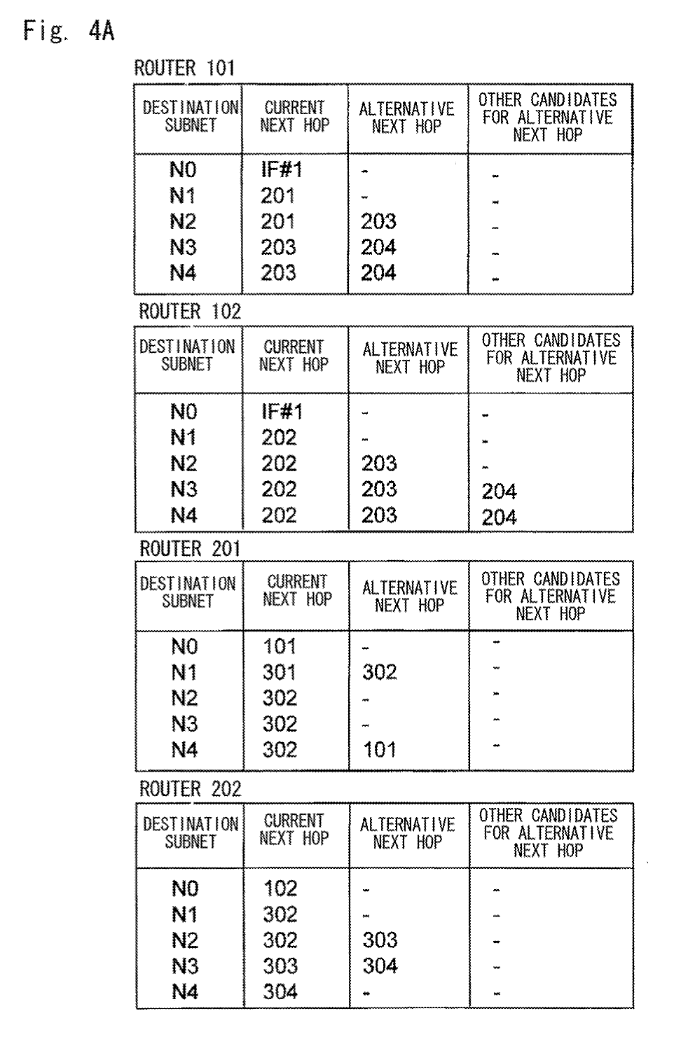

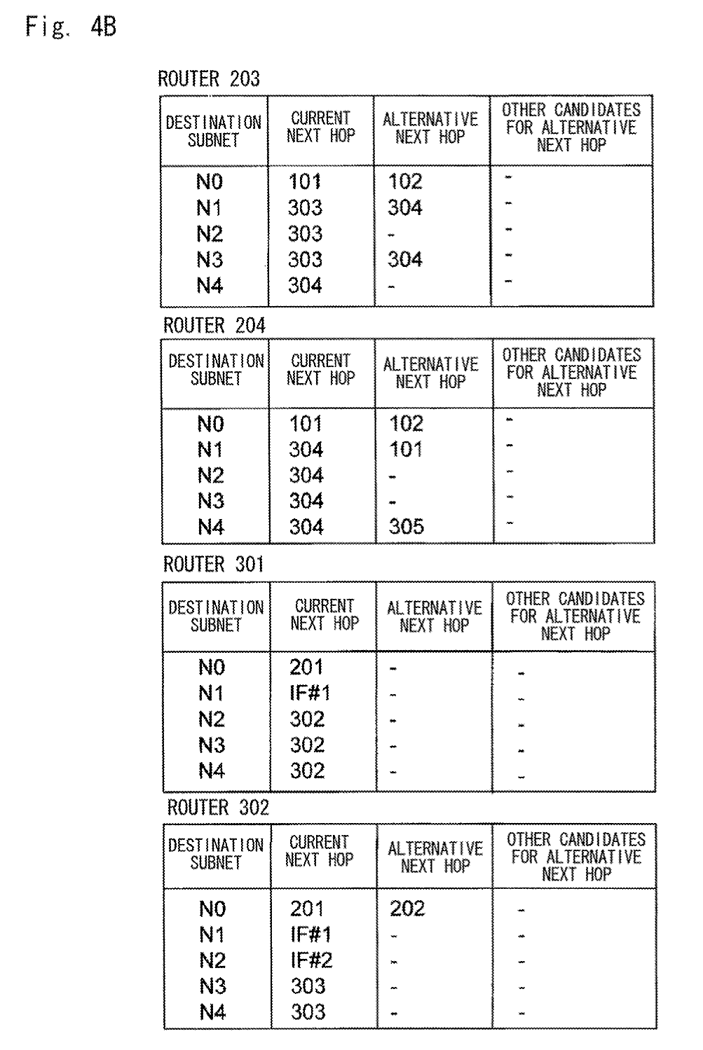

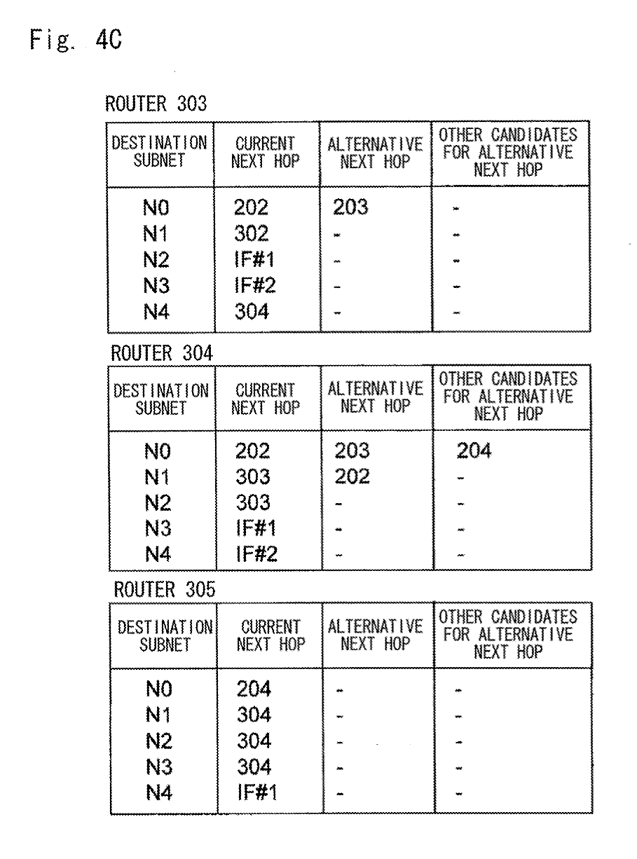

FIGS. 4A to 4C are diagrams showing one example of the route table 22 of each of the routers 101, 102, 201 to 204, and 301 to 305 calculated by the existing routing protocol according to the embodiment of the present invention. The alternative next hop is determined by the method disclosed in non-patent literature 3 and the like stated above.

Further, the traffic statistics processing unit 26 in each of the routers 101, 102, 201 to 204, and 301 to 305 receives the traffic information 35 relayed by the local apparatus.

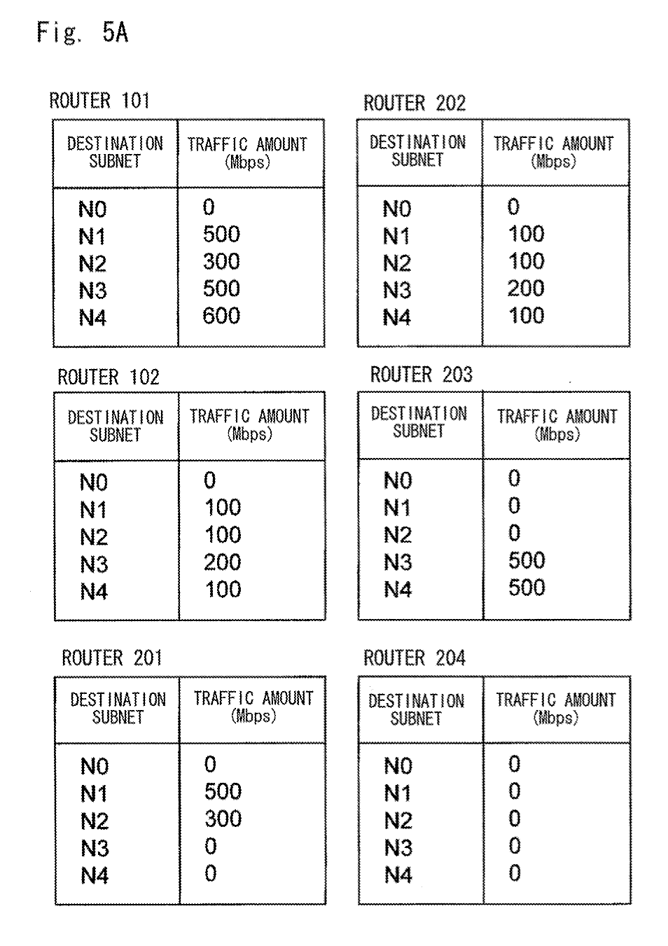

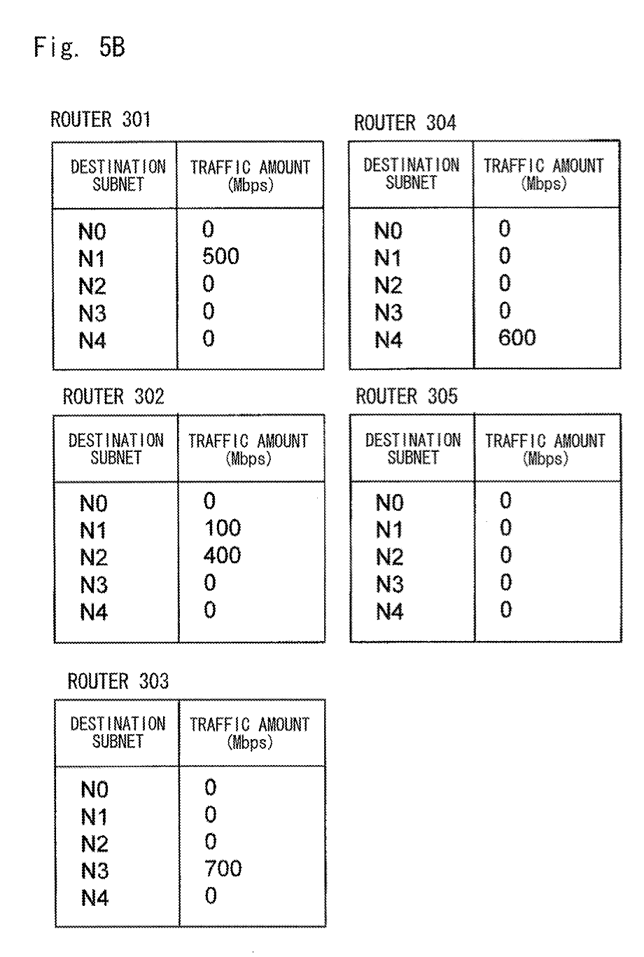

FIGS. 5A and 5B are diagrams showing one example of the traffic information of each of the routers 101, 102, 201 to 204, and 301 to 305 shown in FIG. 3. In this specification, for the sake of simplicity of description, all the traffic are generated from the subnet N0, and the destinations of the traffic are the subnets N1 to N4.

The route summary processing unit 23 of each of the routers 101, 102, 201 to 204, and 301 to 305 creates, from the route table 22 of the current local apparatus and the traffic information calculated by the traffic statistics processing unit 26, the route summary information 33, regularly or when there is a change in the route information 31 or the traffic information 35.

The route summary information 33 includes the information of:

(1) the number of paths (number of destination subnets) which is the current next hop for each adjacent router and the traffic amount for the destination subnet;
(2) the number of paths which is the alternative next hop upon occurrence of fault in the current next hop for each adjacent router and the traffic amount for the destination subnet;
(3) a list of the destination subnet with no alternative next hop; and
(4) transfer capacity of the local apparatus.

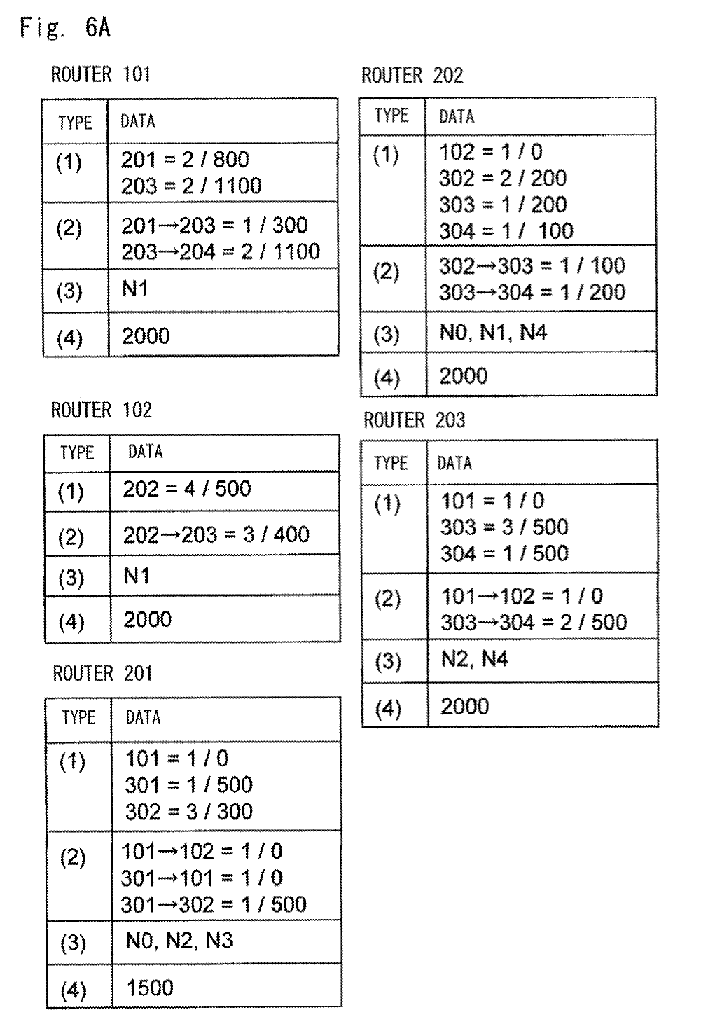

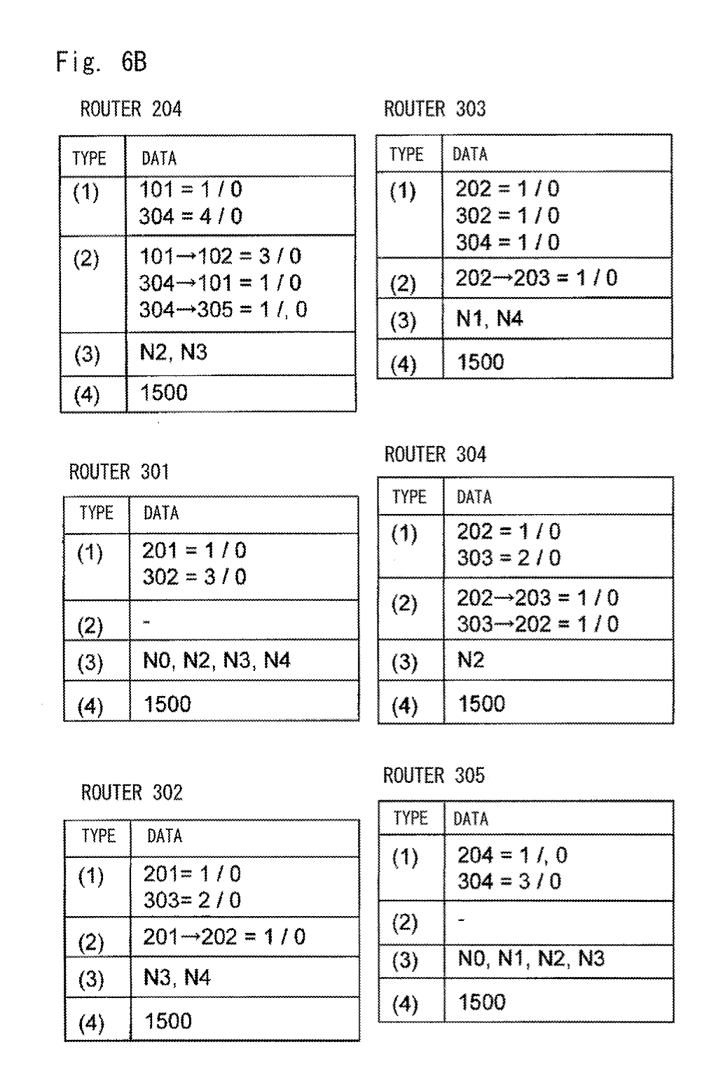

FIGS. 6A and 6B are diagrams showing the route summary information in each of the routers 101, 102, 201 to 204, and 301 to 305 shown in FIG. 3. The route summary information 33 created in each of the routers 101, 102, 201 to 204, and 301 to 305 is transmitted to the adjacent routers.

The route summary information 33 that is received by the adjacent router is recorded in the route summary processing unit 23 of each of the routers 101, 102, 201 to 204, and 301 to 305. The notation of 1/100 or the like shown in (1) or (2) in FIGS. 6A and 6B means that the total number of paths is 1, and the total traffic amount is 100 (Mbps). The same thing is also applied to the following description.

The notation of router 201→router 202 shown in (2) means that the route is bypassed to the router 202 as the alternative next hop when the router 201 is in the fault state.

The fault influence degree information processing unit 24 of each of the routers 101, 102, 201 to 204, and 301 to 305 calculates the fault influence degree information 34 of the local apparatus regularly or when there is a change in the route summary information 33 based on the route summary information 33 received from each of the adjacent routers. The fault influence degree information 34 is the indicator indicating how much influence is given on the adjacent router and the traffic upon occurrence of the fault in the local apparatus.

The fault influence degree information 34 includes the following information of:

(a) the number of destination subnets and the traffic amount in which the local apparatus is the next hop;
(b) the number of destination subnets and the traffic amount bypassed to another node when the local apparatus is in the fault state; and
(c) the number of destination subnets and traffic amount having no alternative next hop when the local apparatus is in the fault state.

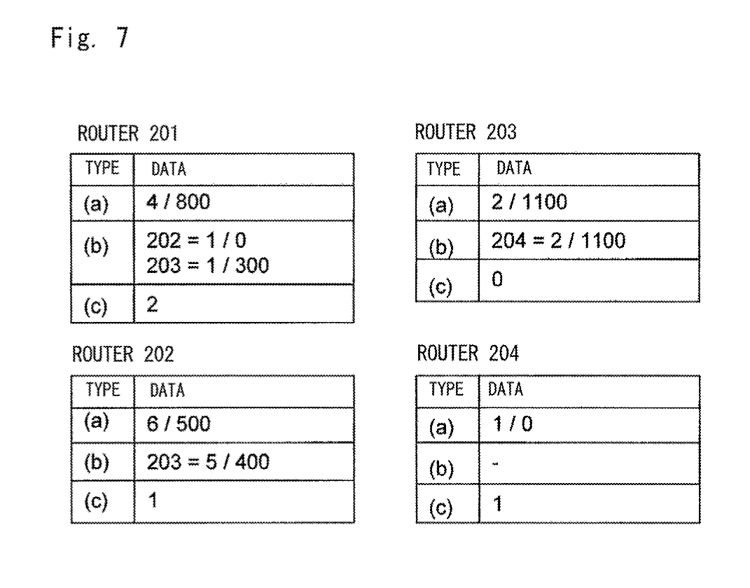

FIG. 7 is a diagram showing the fault influence degree information 34 of each of the routers 201 to 204 shown in FIG. 3. Although other routers 101, 102, 301 to 305 create the fault influence degree information 34 as is similar to the routers 201 to 204, the description will be omitted here. The fault influence degree information 34 that is created is transmitted to the adjacent routers.

The fault influence degree information 34 received from the adjacent router is recorded in the fault influence degree information processing unit 24 of each of the routers 101, 102, 201 to 204, and 301 to 305.

For example, the fault influence degree information 34 of the router 201 shown in FIG. 7 is calculated as follows using the route summary information 33 of the routers 101, 301, and 302 that are adjacent routers:

(a)=estimating the number of paths and the traffic amount in which the local apparatus is the current next hop in (1) of the route summary information 33 of each adjacent router;
(b)=estimating the number of paths and the traffic amount for each alternative router of the local apparatus in (2) of the route summary information 33 of each adjacent router; and
(c)=estimating the difference between the number of paths in which the local apparatus is the current next hop in (1) of the route summary information 33 of each adjacent router and the number of paths including the alternative next hop of the local apparatus in (2) of the route summary information 33 of each adjacent router.

The route adjustment processing unit 25 of each of the routers 101, 102, 201 to 204, and 301 to 305 performs the route adjustment processing regularly or when there is a change in the fault influence degree information 34 or the route summary information 33. The router 101 performs the route adjustment based on the fault influence degree information 34 and the route summary information 33 obtained from the routers 201, 203, and 204. The router 102 performs the route adjustment based on the fault influence degree information 34 and the route summary information 33 obtained from the routers 202, 203, and 204. Although other routers 201 to 204, and 301 to 305 also perform adjustment as is similar to the routers 101 and 102 described above, the description is omitted here.

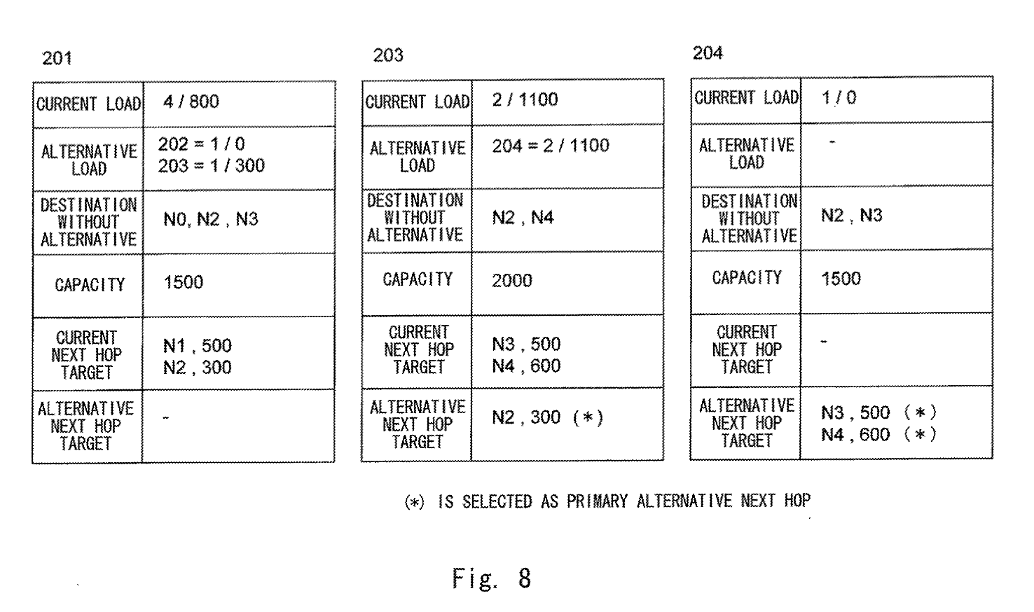

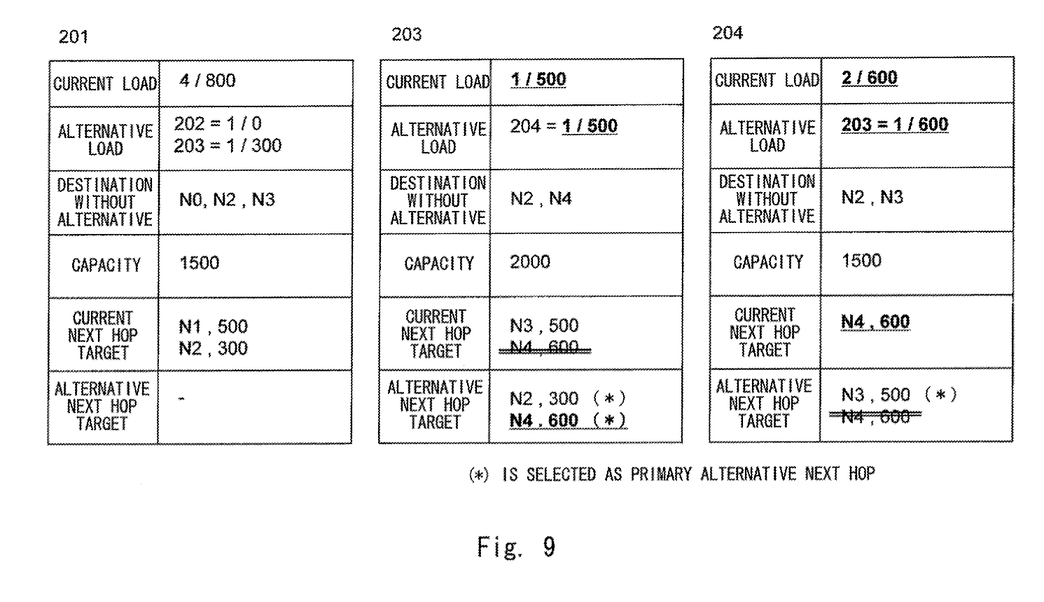

FIG. 8 is a diagram showing adjacent node information extracted by the router 101 shown in FIG. 3, and FIG. 9 is a diagram showing adjacent node information extracted by the router 102 shown in FIG. 3.

The router 101 extracts the adjacent node information as shown in FIG. 8 from the fault influence degree information 34 and the route summary information 33 of the routers 201 to 204, the traffic statistical information, and the route table 22 of the local apparatus. The router 102 also extracts the adjacent node information as shown in FIG. 9 as is similar to the router 101. Now, the process of adjusting the router 101 and the router 102 will be described below.

Step 1: change to next hop having alternative route

The route adjustment processing unit 25 of the router 101 extracts, from the adjacent node information shown in FIG. 8, the destination subnet which is the current next hop target and the destination without alternative. In the example shown in FIG. 8, the subnet N2 of the router 201 and the subnet N4 of the router 203 correspond to the destination subnet which is the destination without alternative. The route adjustment processing unit 25 judges whether the subnet N2 and the subnet N3 are able to be switched to another next hop as follows.

In the Case of Subnet N2

The adjacent node which is the alternative next hop target of the subnet N2 is searched. In this case, the router 203 corresponds to the adjacent node.

It is checked whether the subnet N2 is included in the destination without alternative of the router 203.

Since the subnet N2 is the destination without alternative in the router 203, the current next hop of the subnet N2 is not changed.

In the Case of Subnet N4

The adjacent node which is the alternative next hop target of the subnet N4 is searched. In this case, the router 204 corresponds to the adjacent node.

It is checked whether the subnet N4 is included in the destination without alternative of the router 204.

In the router 204, the subnet N4 is not the destination without alternative (there is an alternative next hop).

Next, the route adjustment processing unit 25 judges whether the current load can be stored.

Since 600 (traffic amount of the subnet N4)<1500 (capacity of the router 204)−0 (current load), the route adjustment processing unit 25 judges that the current load can be stored. Thus, the route adjustment processing unit 25 changes the current next hop of the traffic for the subnet N4 to the router 204.

Note that, when there are a plurality of candidates for alternative next hop of a change destination, the route adjustment processing unit 25 selects an alternative next hop according to the standard such as the smallest rate of the load after change with respect to the capacity (current load+traffic amount of the destination which is to be changed).

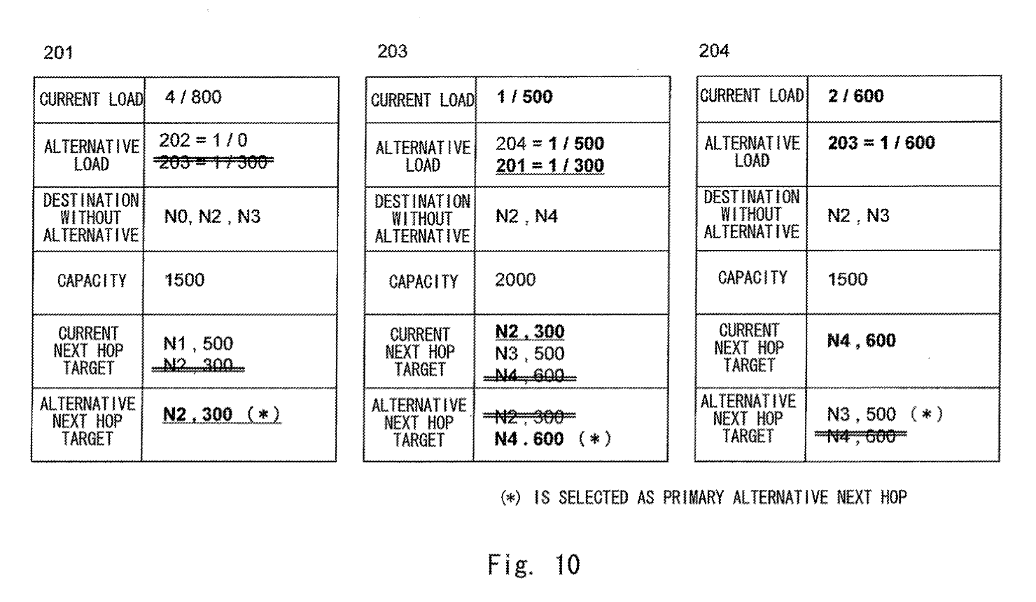

The route adjustment processing unit 25 changes the next hop of the subnet N4 to the router 204, so as to calculate changes of the current load, alternative load, current next hop target, alternative next hop target of the routers 203 and 204, and to change the adjacent node information. The adjacent node information after change will be shown in FIG. 10.

The route adjustment processing unit 25 of the router 102 also performs route adjustment as is similar to the router 101 described above. FIG. 9 shows information of routers adjacent to the router 102 before adjustment. First, the route adjustment processing unit 25 extracts a destination subnet, which is the current next hop target and the destination without alternative. The subnet N1 and the subnet N4 of the router 201 correspond to it.

Since there is no adjacent node which is the alternative next hop target of the subnet N1, the route adjustment processing unit 25 does not perform the processing regarding the subnet N1. Since the subnet N4 includes the router 204 as the alternative next hop target, the route adjustment processing unit 25 checks the destination without alternative of the router 204.

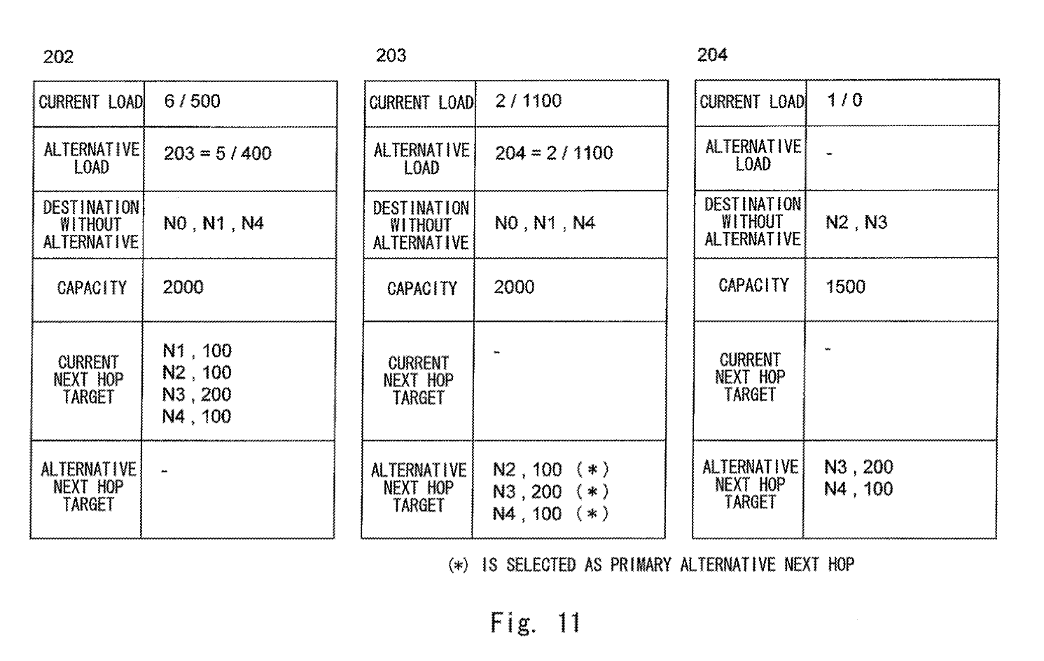

Since the route adjustment processing unit 25 does not include the subnet N4 as the destination without alternative of the router 204, and there is no problem also in terms of the load, the current next hop of the subnet N4 is changed from the router 201 to the router 204. According to this change, the router 102 updates the adjacent node information as is similar to the router 101. The adjacent node information after change will be shown in FIG. 11.

### Step 2: Adjustment of Current Traffic

The router 101 starts calculation from the state shown in FIG. 9, which is the state in which the Step 1 is completed. The rate of the current load to the capacity after change is obtained for each adjacent node.

In the case of FIG. 9,

800/1500=0.53 in the router 201;
500/2000=0.25 in the router 203; and
600/1500=0.4 in the router 204.
Since the rate of the router 201 is the highest and the rate of the router 203 is the lowest, the traffic movement from the router 201 to the router 203 is considered first.

Only the traffic that can be moved from the router 201 to the router 203 is the subnet N2 (subnet N1 is impossible) including the router 203 as the alternative next hop target. Since neither the router 201 nor the router 203 include the alternative route to the subnet N2, it can be judged that the reliability of the traffic to the subnet N2 does not change no matter to which direction the movement is made.

When the subnet N2 is moved to the router 203,

500/1500=0.33 in the router 201; and
800/2000=0.4 in the router 203.

Now, the standard deviation of the load rate is as follows:

before change: √(0.53−0.39)̂2+(0.25−0.39)̂2+(0.4−0.39)̂2=0.198; and
after change: √(0.33−0.376)̂2+(0.4−0.376)̂2+(0.4−0.376)̂2=0.0571.
Thus, the standard deviation of the load rate to the adjacent router decreases. Thus, it is judged in the router 101 that the change should be made, so as to perform change.

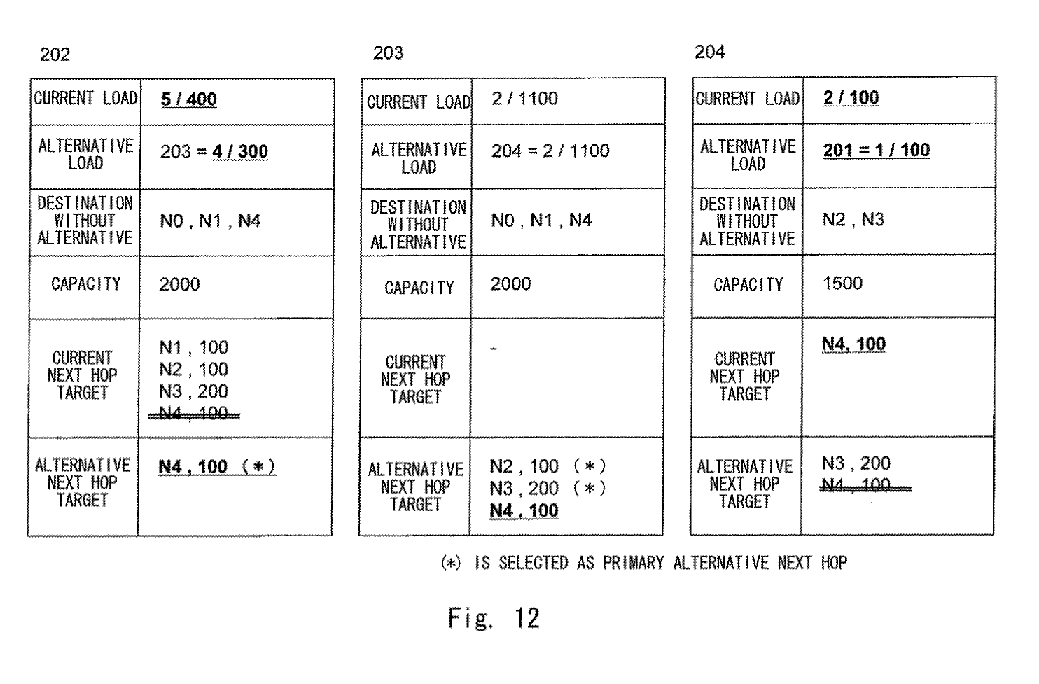

According to this change, the router 101 calculates changes of the current load, alternative load, current next hop target, alternative next hop target, so as to change the adjacent node information. The adjacent node information after change is shown in FIG. 12.

The router 102 also starts adjustment from the state of the adjacent router information shown in FIG. 11 as is similar to the router 101 described above.

In the router 102, the load rate of each adjacent router is:

400/2000=0.2 in the router 202;
1100/2000=0.55 in the router 203; and
100/1500=0.0666 in the router 204.

Since the router 203 does not include a current next hop target destination, no adjustment is possible. The only current next hop target destination that can be changed from the router 201 to the router 204 is the subnet N3 which is the alternative next hop target destination of the router 204. However, since the router 204 does not have the alternative route to the subnet N3, no change is performed. Since there is no other destination that can be changed, the router 102 completes the route adjustment processing.

### Step 3: Adjustment of Alternative Traffic

Since the router 101 has no other alternative next hop candidate as shown in the route table 22 of FIG. 4A, the router 101 cannot switch the alternative next hop and thus does not adjust the alternative traffic.

The router 102 performs adjustment calculation since there are alternative next hop candidates for the subnet N3 and the subnet N4 that are destinations and thus there is room for adjustment. In the state shown in FIG. 11, the combination to change the alternative next hop in the router 102 is as follows. That is,

(1) changing the alternative next hop of the subnet N4 when the router 204 is in the fault state from the router 202 to the router 203; and
(2) changing the alternative next hop of the subnet N3 when the router 202 is in the fault state from the router 203 to the router 204.

First, the router 102 calculates (1). The router 102 adds the current load and the traffic bypassed to the routers 202 and 203 when the router 204 is in the fault state, so as to calculate the rate with the capacity.

The traffic load ratio at the time of substitution of the router 202 before change is (400+100)/2000=0.25, and the traffic load ratio at the time of substitution of the router 203 is (1100+0)/2000=0.55.

The traffic load ratio at the time of substitution of the router 202 after change is (400+0)/2000=0.2, and the traffic load ratio at the time of substitution of the router 203 is (1100+100)/2000=0.6. Since the standard deviation of the load ratio clearly increases, the change is not performed.

Next, the router 102 calculates (2). The router 102 adds the current load and the traffic bypassed to the routers 203 and 204 when the router 202 is in the fault state, so as to calculate the rate with the capacity.

The traffic load ratio at the time of substitution of the router 203 before change is (1100+300)/2000=0.7, and the traffic load ratio at the time of substitution of the router 204 is (100+0)/1500=0.0666 . . . .

The traffic load ratio at the time of substitution of the router 203 after change is (1100+100)/2000=0.6, and the traffic load ratio at the time of substitution of the router 204 is (100+200)/1500=0.2. Since the deviation of the load ratio is changed to be smaller, it is judged that this change is effective, and the router 102 performs the change to the alternative next hop.

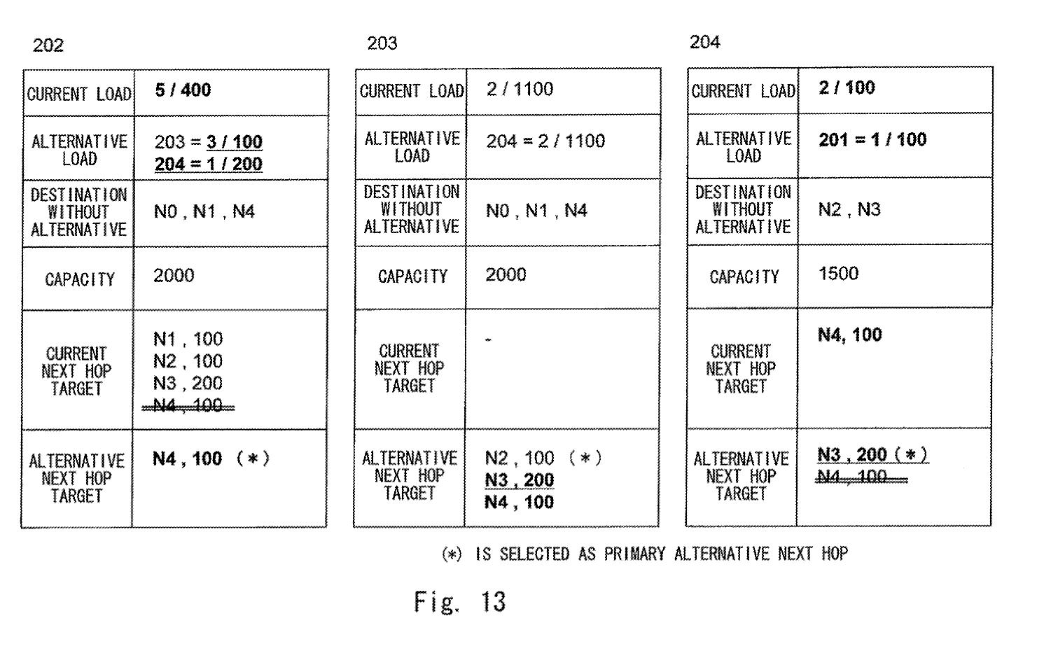

According to this change, the router 102 calculates changes of the current load, alternative load, current next hop target, and alternative next hop target, so as to change the adjacent node information. The adjacent node information after change is shown in FIG. 13.

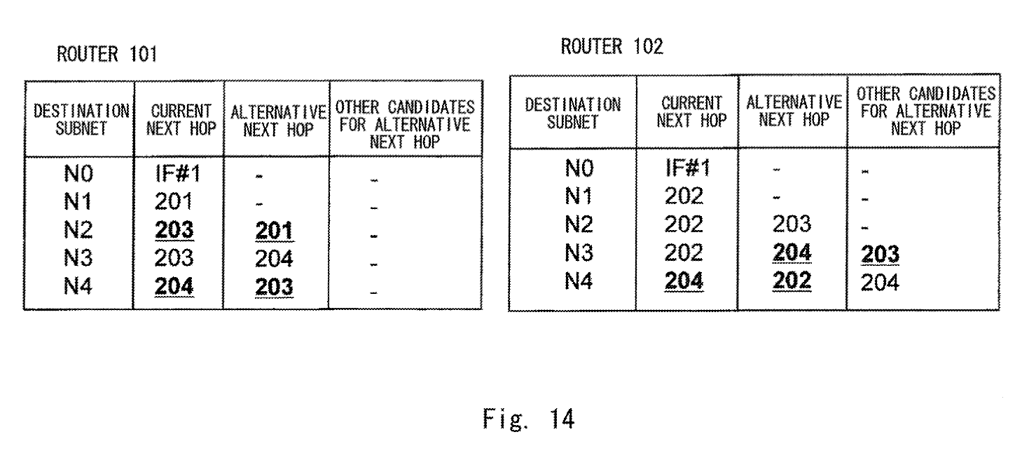

As a result of the adjustment shown in the Steps 1 to 3 above, the route table 22 of the router 101 and the route table 22 of the router 102 are changed as shown in FIG. 14. The adjustment is also performed in other routers 201 to 204, and 301 to 305, as is similar to the routers 101 and 102. This adjustment is asynchronously performed in the routers 101, 102, 201 to 204, and 301 to 305. The route summary information that is updated is advertised after adjustment, and the operation and the adjustment stated above are repeated at regular time intervals.

As described above, according to the embodiment, it is possible to mitigate the traffic in which transfer is interrupted by a fault of a router or a link. Further, according to the embodiment, it is possible to mitigate the occurrence of the congestion due to the traffic bypassed to the alternative next hop upon occurrence of the fault.

According to the present invention, when the deviation cannot be made smaller even when

the current next hop or the alternative next hop of any destination subnet is changed in the Step 2 and the Step 3 of the route adjustment processing described above, the destination subnet can be divided and assigned to another next hop.

For example, in the route adjustment processing of the router 101 of the Step 2 described above, the subnet N2 is divided into two subnets N2-1 and N2-2 so that the traffic amount is substantially halved, so as to change the current next hop of only the subnet N2-2 to the router 203.

Further, the present invention is capable of notifying the route summary information 33 and the fault influence degree information 34 not only to the adjacent routers but also to routers up to N hops ahead. In this case, the present invention increases the value of N, so as to be able to share the information in the whole network to perform route adjustment. Each router performs route adjustment based on the route summary information 33 and the fault influence degree information 34 up to N hops ahead.

Furthermore, the present invention is capable of including in the fault influence degree information 34 the influence degree when each link included in the router is in the fault state. Each router performs route adjustment for the purpose of mitigating the influence degree upon occurrence of fault in the adjacent router and mitigating the influence degree upon occurrence of fault in each link.

Still further, the present invention is capable of performing calculation by weighting the fault influence degree by the fault occurrence probability of each router when performing the route adjustment. The fault occurrence probability can be calculated based on the operating time of the router.

On the other hand, the present invention may employ the conception of the Class of Service as disclosed in the documents 1 and 2, which is a method for priority control to achieve the communication quality or secure bandwidth by dividing a service into a plurality of Classes, to enhance the fault tolerance for each Class even in the environment in which traffic having different delay or bandwidth request is mixed.
Document 1: J. Heinanen et al., Assured Forwarding PHB Group, IETF RFC2597, June, 1999
Document 2: V. Jacobson et al., An Expedited Forwarding PHB, IETF RFC2598, June, 1999

Each router manages the traffic amount for each Class of priority control to achieve at least the communication quality and secure bandwidth, and creates and advertises the current load and the capacity for each Class in the route summary information. Each router executes the route adjustment as is similar to the one described above for each Class, so as to determine the appropriate current next hop and the alternative next hop for each Class.

Although the present invention has been described as the configuration of hardware in the embodiment described above, the present invention is not limited to this. The present invention is able to achieve any processing by causing a CPU (Central Processing Unit) to execute a computer program. In this case, the computer program may be provided by being recorded to a recording medium or by being transmitted by way of the Internet or other communication media. Further, the storage medium includes, e.g., a flexible disk, a hard disk, a magnetic disk, an optical magnetic disk, CD-ROM, DVD, a ROM cartridge, a RAM memory cartridge with battery backup, a flash memory cartridge, and a non-volatile RAM cartridge. Further, the communication media include a wired communication medium (e.g., telephone line) or a wireless communication medium such as a microwave line.

Although the present invention has been described with reference to the embodiment, the present invention is not limited by the above description. The configuration and the detail of the present invention may be variously changed as long as a person skilled in the art can understand within the scope of the present invention.

This application claims the benefit of priority, and incorporates herein by reference in its entirety, the following Japanese Patent Application No. 2008-283808 filed on Nov. 5, 2008.

### REFERENCE SIGNS LIST

11, 12, 101, 102, 201 to 204, 301 to 305 ROUTER
20 PACKET TRANSFER PROCESSING UNIT
21 ROUTE CONTROL PROCESSING UNIT
22 ROUTE TABLE
23 ROUTE SUMMARY PROCESSING UNIT
24 FAULT INFLUENCE DEGREE INFORMATION PROCESSING UNIT
25 ROUTE ADJUSTMENT PROCESSING UNIT
26 TRAFFIC STATISTICS PROCESSING UNIT
30 DATA PACKET
31 ROUTE INFORMATION
32 ROUTE CONTROL INFORMATION
33 ROUTE SUMMARY INFORMATION
34 FAULT INFLUENCE DEGREE INFORMATION
35 TRAFFIC INFORMATION
N0 to N4 SUBNET

1. A communication apparatus comprising:
a route summary processing means that creates route summary information obtained by summarizing route information of a local apparatus from a route table holding route information used for route control and traffic information between communication apparatuses, the route summary processing means further exchanging the route summary information that is created with other communication to apparatuses; and
a fault influence degree information processing means that calculates fault influence degree information indicating a degree of influences on traffic and the other communication apparatuses when the local apparatus is in a fault state, the fault influence degree information processing means further exchanging the fault influence degree information that is calculated with the other communication apparatuses; and
a route adjustment processing means that adjusts the route table of the local apparatus using the route summary information and the fault influence degree information that are obtained by the local apparatus.

2. The communication apparatus according to claim 1, comprising prioritizing a next hop including an alternative next hop indicative of an alternative transfer destination that is not looped in advance when the route table is adjusted.

3. The communication apparatus according to claim 1, comprising prioritizing a traffic amount between current next hops when the route table is adjusted.

4-18. (canceled)

19. The communication apparatus according to claim 2, comprising prioritizing a traffic amount between current next hops when the route table is adjusted.

20. The communication apparatus according to claim 1, comprising changing the alternative next hop indicating the alternative transfer destination that is not looped in advance when the route table is adjusted so that a traffic amount bypassed at a time of fault in the current next hop is smoothed.

21. The communication apparatus according to claim 2, comprising changing the alternative next hop indicating the alternative transfer destination that is not looped in advance when the route table is adjusted so that a traffic amount bypassed at a time of fault in the current next hop is smoothed.

22. The communication apparatus according to claim 3, comprising changing the alternative next hop indicating the alternative transfer destination that is not looped in advance when the route table is adjusted so that a traffic amount bypassed at a time of fault in the current next hop is smoothed.

23. The communication apparatus according to claim 19, comprising changing the alternative next hop indicating the alternative transfer destination that is not looped in advance when the route table is adjusted so that a traffic amount bypassed at a time of fault in the current next hop is smoothed.

24. The communication apparatus according to claim 1, comprising calculating the fault influence degree information upon occurrence of fault in a link of the local apparatus.

25. The communication apparatus according to claim 2, comprising calculating the fault influence degree information upon occurrence of fault in a link of the local apparatus.

26. The communication apparatus according to claim 3, comprising calculating the fault influence degree information upon occurrence of fault in a link of the local apparatus.

27. The communication apparatus according to claim 19, comprising calculating the fault influence degree information upon occurrence of fault in a link of the local apparatus.

28. The communication apparatus according to claim 1, comprising adjusting the route table using the fault influence degree information weighted by fault occurrence probability of each of the plurality of communication apparatuses.

29. The communication apparatus according to claim 2, comprising adjusting the route table using the fault influence degree information weighted by fault occurrence probability of each of the plurality of communication apparatuses.

30. The communication apparatus according to claim 3, comprising adjusting the route table using the fault influence degree information weighted by fault occurrence probability of each of the plurality of communication apparatuses.

31. The communication apparatus according to claim 19, comprising adjusting the route table using the fault influence degree information weighted by fault occurrence probability of each of the plurality of communication apparatuses.

32. The communication apparatus according to claim 1, comprising managing a traffic amount for each Class of priority control to achieve at least communication quality and secure bandwidth, and creating a current load and a capacity in the route summary information for the each Class to advertise the current load and the capacity.

33. The communication apparatus according to claim 2, comprising managing a traffic amount for each Class of priority control to achieve at least communication quality and secure bandwidth, and creating a current load and a capacity in the route summary information for the each Class to advertise the current load and the capacity.

34. The communication apparatus according to claim 3, comprising managing a traffic amount for each Class of priority control to achieve at least communication quality and secure bandwidth, and creating a current load and a capacity in the route summary information for the each Class to advertise the current load and the capacity.

35. The communication apparatus according to claim 19, comprising managing a traffic amount for each Class of priority control to achieve at least communication quality and secure bandwidth, and creating a current load and a capacity in the route summary information for the each Class to advertise the current load and the capacity.

36. The communication apparatus according to claim 32, wherein the route adjustment processing means adjusts the route table of the local apparatus for the each Class, so as to determine the current next hop and the alternative next hop for the each Class.

37. The communication apparatus according to claim 33, wherein the route adjustment processing means adjusts the route table of the local apparatus for the each Class, so as to determine the current next hop and the alternative next hop for the each Class.

38. The communication apparatus according to claim 34, wherein the route adjustment processing means adjusts the route table of the local apparatus for the each Class, so as to determine the current next hop and the alternative next hop for the each Class.

39. The communication apparatus according to claim 35, wherein the route adjustment processing means adjusts the route table of the local apparatus for the each Class, so as to determine the current next hop and the alternative next hop for the each Class.

40. A network comprising the communication apparatus according to claim 1.

41. A network comprising the communication apparatus according to claim 2.

42. A network comprising the communication apparatus according to claim 3.

43. A network comprising the communication apparatus according to claim 19.

44. A route control method, wherein each of a plurality of communication apparatuses that exchange messages performs the following processing of:
route summary processing that creates route summary information obtained by summarizing route information of a local apparatus from a route table holding route information used for route control and traffic information between the communication apparatuses, and exchanges the route summary information that is created with other communication apparatuses;
fault influence degree information processing that calculates fault influence degree information indicating a degree of influences on traffic and the other communication apparatuses when the local apparatus is in a fault state, and exchanges the fault influence degree information that is calculated with the other communication apparatuses; and
route adjustment processing that adjusts the route table of the local apparatus using the route summary information and the fault influence degree information that are obtained by the local apparatus.

45. The route control method according to claim 44, comprising prioritizing a next hop including an alternative next hop indicative of an alternative transfer destination that is not looped in advance when the route table is adjusted.

46. The route control method according to claim 44, comprising prioritizing a traffic amount between current next hops when the route table is adjusted.

47. The route control method according to claim 45, comprising prioritizing a traffic amount between current next hops when the route table is adjusted.

48. The route control method according to claim 44, comprising changing the alternative next hop indicating the alternative transfer destination that is not looped in advance when the route table is adjusted so that a traffic amount bypassed at a time of fault in the current next hop is smoothed.

49. The route control method according to claim 45, comprising changing the alternative next hop indicating the alternative transfer destination that is not looped in advance when the route table is adjusted so that a traffic amount bypassed at a time of fault in the current next hop is smoothed.

50. The route control method according to claim 46, comprising changing the alternative next hop indicating the alternative transfer destination that is not looped in advance when the route table is adjusted so that a traffic amount bypassed at a time of fault in the current next hop is smoothed.

51. The route control method according to claim 47, comprising changing the alternative next hop indicating the alternative transfer destination that is not looped in advance when the route table is adjusted so that a traffic amount bypassed at a time of fault in the current next hop is smoothed.

52. The route control method according to claim 44, comprising calculating the fault influence degree information upon occurrence of fault in a link of the local apparatus.

53. The route control method according to claim 45, comprising calculating the fault influence degree information upon occurrence of fault in a link of the local apparatus.

54. The route control method according to claim 46, comprising calculating the fault influence degree information upon occurrence of fault in a link of the local apparatus.

55. The route control method according to claim 47, comprising calculating the fault influence degree information upon occurrence of fault in a link of the local apparatus.

56. The route control method according to claim 44, comprising adjusting the route table using the fault influence degree information weighted by fault occurrence probability of each of the plurality of communication apparatuses.

57. The route control method according to claim 45, comprising adjusting the route table using the fault influence degree information weighted by fault occurrence probability of each of the plurality of communication apparatuses.

58. The route control method according to claim 46, comprising adjusting the route table using the fault influence degree information weighted by fault occurrence probability of each of the plurality of communication apparatuses.

59. The route control method according to claim 47, comprising adjusting the route table using the fault influence degree information weighted by fault occurrence probability of each of the plurality of communication apparatuses.

60. The route control method according to claim 44, wherein each of the plurality of communication apparatuses manages a traffic amount for each Class of priority control to achieve at least communication quality and secure bandwidth, creates a current load and a capacity in the route summary information for the each Class to advertise the current load and the capacity.

61. The route control method according to claim 45, wherein each of the plurality of communication apparatuses manages a traffic amount for each Class of priority control to achieve at least communication quality and secure bandwidth, creates a current load and a capacity in the route summary information for the each Class to advertise the current load and the capacity.

62. The route control method according to claim 46, wherein each of the plurality of communication apparatuses manages a traffic amount for each Class of priority control to achieve at least communication quality and secure bandwidth, creates a current load and a capacity in the route summary information for the each Class to advertise the current load and the capacity.

63. The route control method according to claim 47, wherein each of the plurality of communication apparatuses manages a traffic amount for each Class of priority control to achieve at least communication quality and secure bandwidth, creates a current load and a capacity in the route summary information for the each Class to advertise the current load and the capacity.

64. The route control method according to claim 60, wherein each of the plurality of communication apparatuses adjusts the route table of the local apparatus for the each Class in the route adjustment processing, so as to determine the current next hop and the alternative next hop for the each Class.

65. The route control method according to claim 61, wherein each of the plurality of communication apparatuses adjusts the route table of the local apparatus for the each Class in the route adjustment processing, so as to determine the current next hop and the alternative next hop for the each Class.

66. The route control method according to claim 62, wherein each of the plurality of communication apparatuses adjusts the route table of the local apparatus for the each Class in the route adjustment processing, so as to determine the current next hop and the alternative next hop for the each Class.

67. The route control method according to claim 63, wherein each of the plurality of communication apparatuses adjusts the route table of the local apparatus for the each Class in the route adjustment processing, so as to determine the current next hop and the alternative next hop for the each Class.

68. A non-transitory computer readable medium that stores a program to make a computer to execute the following processing of:
creating route summary information obtained by summarizing route information of a local apparatus from a route table holding route information used for route control and traffic information between communication apparatuses, and exchanging the route summary information that is created with other communication apparatuses;
calculating fault influence degree information indicating a degree of influences on traffic and the other communication apparatuses when the local apparatus is in a fault state, and exchanging the fault influence degree information that is calculated with the other communication apparatuses; and
adjusting the route table of the local apparatus using the route summary information and the fault influence degree information that are obtained by the local apparatus.
